(19) United States
(12) Patent Application Publication
(10) Pub. No.: US 2020/0351620 A1
(43) Pub. Date: Nov. 5, 2020

(54) SYSTEM AND METHOD FOR TRACKING JOBSITE PRODUCTS

(71) Applicant: BLACK & DECKER INC., New Britain, CT (US)

(72) Inventors: Daniele C. BROTTO, Baltimore, MD (US); Brice D. FARRELL, Damascus, MD (US); Raghavendra R. BYATNAL, Cockeysville, MD (US); Thuong Ngoc Minh NGUYEN, Towson, MD (US)

(21) Appl. No.: 16/931,075

(22) Filed: Jul. 16, 2020

Related U.S. Application Data
(63) Continuation of application No. PCT/US2019/013960, filed on Jan. 17, 2019.
(60) Provisional application No. 62/620,524, filed on Jan. 23, 2018.

(51) Int. Cl. H04W 4/029; H04W 4/48; H04W 4/024; G07C 5/00; G07C 5/08; G01S 19/01

(52) U.S. Cl. CPC H04W 4/029; H04W 4/48; H04W 4/024; G07C 2205/02; G07C 5/0816; G01S 19/01; G07C 5/008

(57) ABSTRACT

An apparatus may be connectable to a vehicle via an OBD-2 connection. Such apparatus includes a housing, a processor disposed within the housing, a non-transitory computer readable medium connected to the processor, and a wireless communication circuit connected to the processor. The wireless communication circuit is connectable to an electronic device disposed outside of the housing for transmitting data from the processor to the electronic device.

### CROSS-REFERENCE TO RELATED APPLICATIONS

This application is a continuation of international application PCT/US2019/013960, filed Jan. 17, 2019 which claims benefit of Provisional Application No. 62/620,524 filed Jan. 23, 2018, the disclosures of which are incorporated herein by reference in their entirety.

### FIELD OF INVENTION

The present invention relates to computer data network systems, in which different products, including power tools and other construction jobsite products, are connected by means of wireless signal transmissions for tracking thereof.

### BACKGROUND OF THE INVENTION

Location systems are used for locating, and preferably tracking, articles. Location systems are used in a wide range of environments, including hospitals and other healthcare situations, social care environments, prisons, industrial locations, warehouses, retail stores, educational institutions, offices and logistics environments, for example. Such systems are used for locating and tracking patients (especially babies and the elderly) and other categories of people, and for locating and tracking medical supplies, equipment, products, tools and other categories of articles.

Such location systems have not been implemented in construction jobsites due to the lack of network infrastructure, the lack of durable network components, and the inability to provide a temporary network that is easily assembled at the beginning or the construction project and disassembled after the construction project has been completed. Such location system is described in U.S. Patent Application Ser. No. 62/370,292, filed on Aug. 3, 2016, and entitled “CONSTRUCTION JOBSITE COMPUTER DATA NETWORK AND LOCATION SYSTEM,” which is hereby fully incorporated herein by reference. Such system however does not support locating jobsite items, such as tools, gear and materials, as they are transported to or from the jobsite.

### DESCRIPTION OF THE DRAWINGS

Preferred embodiments of the invention will now be described, by way of example, with reference to the accompanying drawings, of which:

FIG. 1 is a system diagram of a computer network; and

FIG. 2 illustrates a vehicle-based computer network.

### DETAILED DESCRIPTION

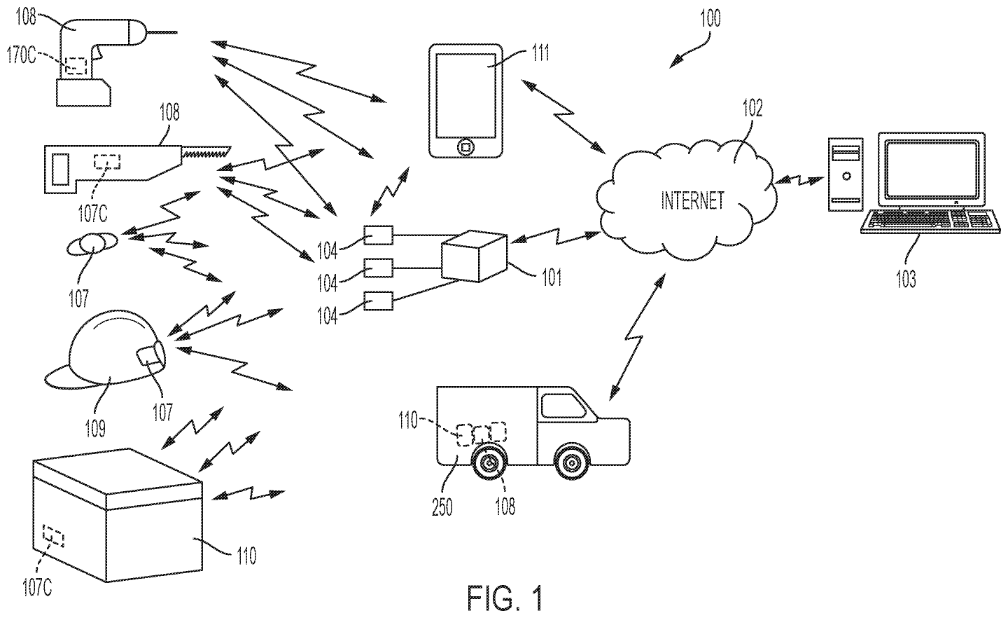

FIG. 1 illustrates a computer network 100 for a construction jobsite. The computer network 100 preferably includes a local server 101 disposed in the construction jobsite connected to the internet 102. Persons skilled in the art will recognize that local server 101 is preferably connected to the internet 102 via at least one of the following connections: digital subscriber lines (DSL), asymmetric digital subscriber lines (ADSL), symmetric digital subscriber lines (SDSL), very high digital subscriber lines (VDSL), cable-broadband internet connection, wireless broadband connection, T-1 lines, bonded T-1 lines, T-3 lines, optical carrier lines (OC3), internet over satellite (IoS), etc.

Computer network may also include network access transceivers 104. Transceivers 104 may be connectable to the local server 101 via a wired connection, such as an Ethernet network, and/or one or more of a variety of wireless technologies, including: wireless local area network (WLAN) technologies; wireless personal area network (WPAN) technologies (including low-rate wireless personal area network (LR-WPAN) technologies); radio frequency identification (RFID); ultra-wideband (UWB); ultrasound; sound; infrared; visible light; camera vision, etc. Included in WLAN technologies are those conforming to the Institute of Electrical and Electronics Engineers (IEEE) 802.11 series of standards (e.g. Wi-Fi™). Included in WPAN and LR-WPAN technologies are those conforming to the IEEE 802.15 series of standards (e.g. Bluetooth™, ZigBee™, etc.).

Such different wireless communication circuits allow transceiver 104 to communicate with different devices, such as personal computing devices (such as tablets or smartphones 111), and tags 107 disposed in or attached to an asset, such as a power tool 108, a wearable item 109 (such as a vest or helmet) worn by a worker, and/or a construction material 110 (such as boards, pipes, slabs, etc.), etc. Persons skilled in the art will recognize that power tool 108, a battery pack 108B attached to the power tool 108, wearable item 109 and/or the construction material 110 may have a communication circuit 107C disposed within, which would interacting with transceiver 104 in the same manner as tag 107, while preferably providing further features and advantages as described in US Patent Publication No. 2014/0107853, entitled “SYSTEM FOR ENHANCING POWER TOOLS,” which is hereby fully incorporated by reference. Communication circuits 107C may allow communication therebetween, for example, between battery pack 108B and the power tool 108 the battery pack 108B is powering, with another power tool 108 that the battery pack 108B is not connected to.

Persons skilled in the art will recognize that smartphones 111, communication circuits 107C and tags 107 may use more than one communication protocol to communicate with transceiver 104. For example smartphone 111 may communicate with transceiver 104 via a Bluetooth circuit and a WLAN/Wi-Fi circuit, etc. Similarly, communication circuit 107C and/or tag 107 may communicate with transceiver 104 via a Bluetooth circuit and WLAN/Wi-Fi circuit, etc. Persons skilled in the art are referred to U.S. Pat. No. 9,357,348, which is hereby fully incorporated by reference, for further information on the functionality and components of tag 107.

With such arrangement, information can be passed along between tags 107, power tool 108, battery pack 108B, wearable item 109 and/or the construction material 110 to a central server 103, which is connected to the internet 102.

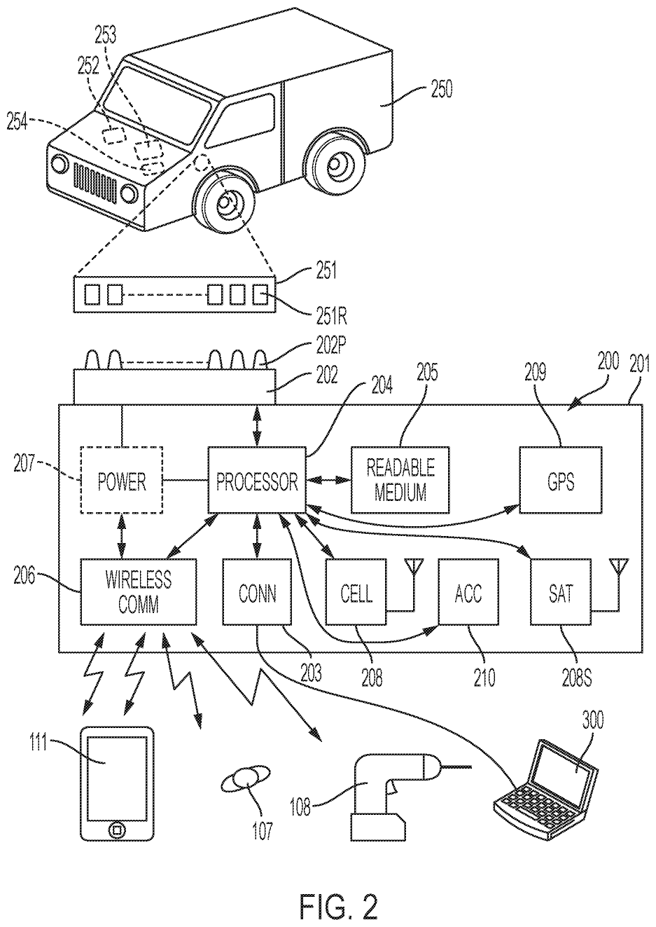

Because tags 107, power tool 108, battery pack 108B, wearable item 109 and/or the construction material 110 have these wireless communication circuits, it may be beneficial to provide vehicle 250 with a communication circuit for interacting with these tags 107, power tools 108, battery packs 108B, wearable items 109 and/or the construction materials 110 during transportation. Referring to FIG. 2, an apparatus 200 may be used for interacting with these tags 107, power tools 108, battery packs 108B, wearable items 109 and/or the construction materials 110 during transportation.

Apparatus 200 may be attached to vehicle 250 or electrically connected to vehicle 250, e.g., to a 12V cigarette lighter/accessory socket. Preferably, the apparatus 200 comprises a case component 201, including a first side comprising a male connector 202 and a second side of the case component including a second connector 203. The male connector 202 preferably includes plural pins 20 for connecting to a female on-board diagnostic series 2 (OBD-2) port 251 integral to vehicle 250 with plural electronic receptacles 251R for receiving the plural pins 202P from the male connector 202.

Persons skilled in the art shall recognize that the shape of the male connector 16 in the drawing in FIG. 2 is exemplary only and for simplicity and does not show all sixteen pins required for an OBD-2 connector. Similarly, the female OBD-2 port 22 shown in FIG. 2 does not include all sixteen receptacles 26 required for an OBD-2 receptacle. Further information on an OBD-2 system may be found in U.S. Pat. No. 9,418,491, which is fully incorporated herein by reference.

The apparatus 200 may further include a processor 204 inside the case component 201 preferably connected to the male connector 202, the second connector 203, a non-transitory computer readable medium 205, a wireless communication circuit 206, a cellular data network communication circuit 208, a satellite data network communication circuit 208S, a global positioning system (GPS) circuit 209 and/or other sensors, such as accelerometer 210.

A power circuit 207 may be provided inside case component 201 to power the processor 204, the second connector 203, a non-transitory computer readable medium 205, the wireless communication circuit 206, the cellular data network communication circuit 208, the satellite data network communication circuit 208S, the global positioning system (GPS) circuit 209 and/or other sensors. Power circuit 207 may receive power from vehicle 250 via the connectors 202, 251 and/or receive power from a battery (not shown) provided within case component 201.

Power circuit 207 may have a battery. The battery is preferably rechargeable and may be charged power received from vehicle 250 via the connectors 202, 251 and/or a separate dedicated charger. Providing a battery would allow apparatus 200 to operate regardless of whether apparatus 200 was connected to vehicle 250 or separated therefrom.

Second connector 203 may have a USB port for connecting to a computer 300 and/or any other ports for connecting to other devices. Through this connector 203, computer 300 may receive data from processor 204, non-transitory computer readable medium 205 and/or vehicle 250, as well as send data and/or instructions to processor 204 and/or vehicle 250. This data can be stored in the non-transitory computer readable medium 205, or transmitted to smartphones 111, tags 107, power tool 108, battery pack 108B, wearable item 109 and/or construction material 110.

The wireless communication circuit 206 may be used to communicate with smartphones 111, tags 107, and the communication circuits 107C of power tool 108, battery pack 108B, wearable item 109 and/or construction material 110. Wireless communication circuit 206 may also communicate wirelessly with computer 300. Wireless communication circuit 206 may include a Bluetooth circuit, a WLAN/Wi-Fi circuit, and any other desirable communication circuits, such as IEEE 802.11a, 802.11b, 802.11g, 802.11n, 802.15.4 (ZigBee), “Worldwide Interoperability for Microwave Access” (WiMAX), ETSI High Performance Radio Metropolitan Area Network (HIPERMAN) or “RF Home, Zigbee, Bluetooth, Infrared, Industrial, Scientific and Medical” (ISM), or other long range or short range wireless interfaces.

Cellular data network communication circuit 208 can connect apparatus 200 to a cellular data network, and upload data to a cloud service or central server 103. Cellular data network communication circuit 208 may include, but is not limited to Code Division Multiple Access (CDMA), Time Division Multiple Access (TDMA), or other wireless technologies, via Packet Cellular Network (PCN), Global System for Mobile Communications (GSM), Generic Packet Radio Services (GPRS), network/Personal Communications Services network (PCS), a Cellular Digital Packet Data (CDPD), Long Term Evolution (LTE), and/or other wireless interfaces.

Satellite data network communication circuit 208S can connect apparatus 200 to a satellite data network, and upload data to a cloud service or central server 103.

With such arrangement, the processor 204 can query, transmit and/or receive information to/from computer 300, smartphone 111, tags 107, and the communication circuits 107C of power tool 108, battery pack 1088, wearable item 109 and/or construction material 110. For example, processor 204 can receive data from tags 107 and store such data in the non-transitory computer readable medium 205.

Alternatively, processor 204 can receive instructions from central server 103, smartphone 111 and/or computer 300 to change a parameter of power tool 108 and/or battery pack 1088. Processor 204 would activate the wireless communication circuit 206, which interfaces with the communication circuit 107C of power tool 108 and/or battery pack 1088, exchange data as necessary and cause a processor in power tool 108 and/or battery pack 1088 to change the desired parameter. Processor 204 can then activate the cellular data network communication circuit 208 and/or satellite data network communication circuit 208S to update the data records on the cloud services for power tool 108 and/or battery pack 1088, which could then be seen on local server 101, central server 103, smartphone 111 and/or computer 300, etc.

Processor 204 can also activate wireless communication circuit 206 to contact and poll all nearby responsive items, including smartphone 111, tags 107, and the communication circuits 107C of power tool 108, battery pack 1088, wearable item 109 and/or construction material 110. Processor 204 can then activate the cellular data network communication circuit 208 and/or satellite data network communication circuit 208S to report all the responsive items located near vehicle 250, which can then be seen on the central server 103 and/or smartphone 111.

Processor 204 may also query vehicle 250 via the connection between connectors 202, 251 to receive time and geo-location data from the plural individual components of the vehicle 250, e.g., the on-board Global Positioning System (GPS) module 252 and clock 253 of vehicle 250. Such data can be stored in the non-transitory computer readable medium 205 or sent to the cloud services for access by the central server 103 and/or smartphone 111, etc. Persons skilled in the art will recognize that processor 204 may query the GPS circuit 209 and/or a GPS circuit in smartphone 111, in addition to or instead of GPS module 252, especially if vehicle 250 does not have a GPS module 252.

Persons skilled in the art shall recognize that having access to the GPS information, whether it comes from GPS circuit 209, smartphone 111 or GPS module 252, is advantageous as such information effectively provides the approximate location of nearby power tools 108, battery packs 1088, wearable items 109 and/or construction materials 110, etc. With such arrangement, the user can program a geographic region via a smartphone 111, central server 103 or computer 300 so that, when the approximate location of a nearby power tool 108, battery pack 1088, wearable item 109 and/or construction material 110, etc. according to the GPS information is within or without the geographic region, a specific action occurs.

For example, the user may program an alarm when a wearable item 109 is within a particular geographic region, Similarly, the user may program that, when a battery pack 1088 is outside a particular geographic region, the battery pack 1088 will sound an alarm and/or shut down. Preferably, the user can access a map, define the geographic region by defining the boundaries of the region (possibly by drawing a square on the screen or inputting particular coordinates), selecting the item to monitor, and a resulting action when the item is within or without the geographic region.

Persons skilled in the art shall recognize that vehicle 250 may have a cellular or satellite data network communication circuit 254. Processor 204 may recognize the presence of such circuit when the apparatus 200 is connected to the connector 251, and use that communication circuit 254 to transmit and receive data from central server 103, local server 101, etc., instead of using cellular data network communication circuit 208.

Persons skilled in the art will recognize that processor 204 may monitor the output of accelerometer 210. Processor 204 may use such output to monitor when vehicle 250 is stationary or moving, to minimize power consumption of apparatus 200 (e.g., when vehicle 250 is stationary for a predetermined period of time) to minimize power draw on the battery of vehicle 250, etc.

It will be understood that the above description and the drawings are examples of particular implementations of the invention, but that other implementations of the invention are included in the scope of the claims.

What is claimed is:

1. An apparatus connectable to a vehicle via an OBD-2 connection, the apparatus comprising:
a housing;
a processor disposed within the housing;
a non-transitory computer readable medium connected to the processor;
a wireless communication circuit connected to the processor, wherein the wireless communication circuit is connectable to an electronic device disposed outside of the housing for transmitting data from the processor to the electronic device.

2. The apparatus of claim 1, wherein the wireless communication circuit communicates wirelessly with the electronic device via at least one of a BlueTooth communication circuit, a WLAN/Wi-Fi communication circuit, a cellular data network communication circuit, a satellite data network communication circuit and a Zigbee communication circuit.

3. The apparatus of claim 1, further comprising a USB connector for connecting to a computer.

4. The apparatus of claim 3, wherein the computer provides data to the controller via the USB connector.

5. The apparatus of claim 1, further comprising a GPS module connected to the controller.

6. The apparatus of claim 5, wherein the controller queries the GPS module for location information.

7. The apparatus of claim 6, wherein the controller transmits location information data received from the GPS module to the electronic device.

8. The apparatus of claim 1, wherein the electronic device is one of a personal computing device, a tag, and a power tool.
